(19) United States
(12) Patent Application Publication
(10) Pub. No.: US 2008/0117026 A1
(43) Pub. Date: May 22, 2008

(54) Remote Control

(75) Inventors: Robert Hupfer, Rochester, MI (US); Hans-Peter Landgraf, Weilheim (DE)

Correspondence Address: ROBERTS, MLOTKOWSKI & HOBBES, P. O. BOX 10064, MCLEAN, VA, 22102-8064, US

(73) Assignee: Webasto AG, Stockdorf (DE)

(21) Appl. No.: 11/665,450

(22) PCT Filed: Oct. 4, 2005
(86) PCT No.: PCT/EP05/10668

§ 371 Date: Nov. 6, 2007

(30) Foreign Application Priority Data
Oct. 14, 2004 (DE) 10 2004 050 120.3

(51) Int. Cl. H04Q 5/22

(52) U.S. Cl. 340/10.6; 340/825; 340/10.1

(57) ABSTRACT

A remote control for operation of functions of a motor vehicle, including a multimedia data memory; and means for managing the multimedia data memory by a user for performing operation of functions of a motor vehicle. The functions of the motor vehicle the operation of which are controlled include at least one of heating, ventilation, air conditioning, interlock, antitheft protection, and interrogation of vehicle states and characteristics, including at least one of temperatures and electrical system voltages.

### BACKGROUND OF THE INVENTION

1. Field of Invention

The present invention generally relates to a remote control, and more particularly to an improved remote control for operation of enhanced functions of a motor vehicle.

2. Description of Related Art

There are a host of remote controls for performing varied functions. Examples include remote controls for operation of audio and/or video devices, remote controls for operation of household appliances, and remote controls for operation of enhanced functions of motor vehicles. Such remote controls send control commands by radio, infrared, and/or ultrasound.

### SUMMARY OF THE INVENTION

An object of the invention is to further develop remote controls, such that their domain of operation is widened.

The above and other objects are achieved by the exemplary embodiments of the present invention, which provide a remote control for operation of functions of a motor vehicle, including a multimedia data memory; and means for managing the multimedia data memory by a user for performing operation of functions of a motor vehicle.

Advantageous embodiments and developments of the present invention will become apparent from the detailed description and drawing of the exemplary embodiments.

### BRIEF DESCRIPTION OF THE DRAWINGS

The sole FIGURE shows a schematic, partially transparent representation of one embodiment of an exemplary remote control, including means for reproduction of multimedia data, which can be connected to the exemplary remote control.

### DETAILED DESCRIPTION OF THE INVENTION

The remote control of the exemplary embodiments is based on a multimedia data memory which can be managed by a user. The multimedia data memory can be formed, for example, by a flash memory, an EEPROM and/or a RAM. In these data memories, the data travel via a high-speed serial or parallel data interface to the memory and can be retrieved again on the same path. The concept of “multimedia” in this connection should be broadly interpreted, to include, in addition to typical multimedia data, data to be stored in the multimedia data memory, for example, such as a personal address book or the like of a user. Since mobile storage of data and their mobile use are becoming more and more important, it can be assumed that the user will very often have the remote control of the exemplary embodiments with them. In contrast, with respect to the use of mobile radio services (e.g., such as GSM, UMTS, etc.), it is preferable for the remote control of the exemplary embodiments that data transfer takes place at no cost.

In addition, the remote control of the exemplary embodiments can be used for operation of enhanced functions of a motor vehicle, such as independent vehicle heating, independent vehicle ventilation, independent vehicle air conditioning, vehicle interlock, antitheft protection, and interrogation of various states and characteristic quantities, such as temperatures and vehicle electrical system voltages.

The remote control of the exemplary embodiments can include means for reproduction of multimedia data. These means can be formed, for example, by a suitable display and/or at least one speaker.

Furthermore, the remote control of the exemplary embodiments can include at least one first interface to which means for reproduction of multimedia data can be connected. The means for reproduction of multimedia data can be formed for example by a headset and/or a separate display.

Furthermore, the remote control of the exemplary embodiments can include means for compression and/or decompression of multimedia data. The means for compression and/or decompression of multimedia data can be formed in any suitable conventional manner, for example, by hardware and/or software, as would be known to one skilled in the relevant art(s).

The remote control of the exemplary embodiments can include at least a second interface via which configuration data, remote control data and/or multimedia data can be sent and/or received over a cable, by radio, optically and/or by ultrasound. The second interface can be for example a USB or FireWire interface via which data can be exchanged, for example, with a computer. Moreover, the second interface (or also any other suitable interface) can be designed to relay the actual remote control commands.

The remote control of the exemplary embodiments can include a charge controller for charging at least one energy storage device, which can supply the remote control with power. Although fundamentally the use of an interchangeable primary battery is also possible, a rechargeable battery is preferred with a charging state, which can optionally be displayed on a display. The rechargeable battery can be charged, for example, via an interface to the computer (e.g., USB, FireWire/IEEE1394, etc.).

In further exemplary embodiments, the multimedia data memory is also designed to store audio, photo, and/or video data. Fundamentally, the format of the data which can be stored in the multimedia data memory is optional. However, it can be advantageous to employ the data formats of the data files reproduced by the remote control itself to current exemplary standards. Standards which are conventional at present are, for example:

for audio: WMA, AAC, MPEG-3(MP3), etc.;

for photo: JPEG; and

for video: MPEG-4.

The remote control of the exemplary embodiments can include at least one operating element. Operating elements include, for example, so-called “jog-dial” actuating elements and/or any suitable buttons and pointing devices, such as for example a touch-pad or the like.

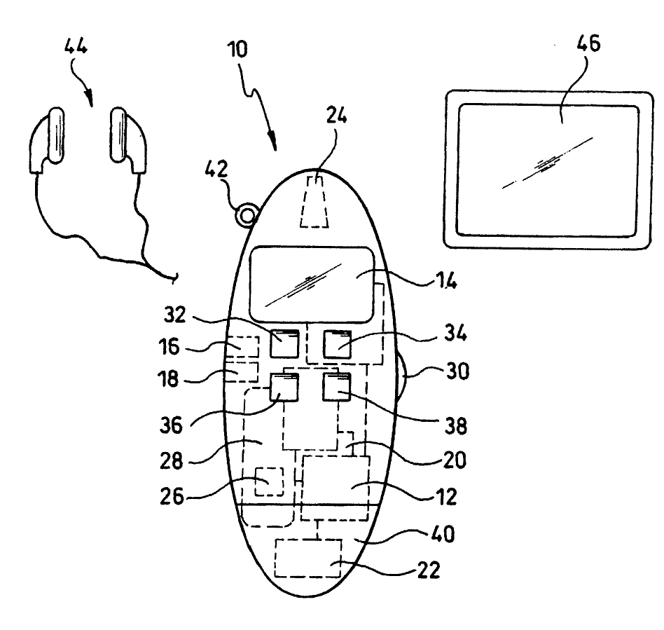

Referring now to the drawing, there is illustrated in FIG. 1 a remote control 10 for operation of enhanced functions of a motor vehicle, such as independent vehicle heating, independent vehicle ventilation, independent vehicle air conditioning, vehicle interlock, antitheft protection, etc. The remote control has a multimedia data memory 12, which can be formed, for example, by a flash memory, an EEPROM and/or RAM. Furthermore, it is possible for the multimedia data memory to be replaceable by the user, such as with a memory card or the like.

The means for reproduction of the multimedia data are displayed in the form of a display 14. Optionally, there can additionally or alternatively be a means for reproduction of electro-acoustic signals, for example, via a speaker (not shown). There is provided a first interface in the form of a first jack 16 and a second jack 18. A headset 44 as a means for reproduction of multimedia data can be connected to the first jack 16, while an additional display 46, which can be provided, for example, to be larger than the display 14 and/or with higher resolution, can be connected to the second jack 18.

In order to be able to file as large an amount of data as possible in the multimedia data memory 12, there are means for compression and decompression of multimedia data, which are formed by a microprocessor-based control means 20. The control means 20 is moreover designed to control all suitable operation of the remote control 10, which also includes physical management of the multimedia data memory 12.

Furthermore, there is provided a second interface 22, 24, which comprises a radio antenna 24 and a data interface 22, which is located under a removable cap 40, for example, an USB or IEEE 1394 interface or the like. The remote control 10 can send and receive configuration data, remote control data and multimedia data via the second interface 22, 24. This can take place over cable, by radio, optically and/or by ultrasound.

Furthermore, there is provided a charge controller 26 with which an energy storage device 28 in the form of a battery can be charged. The external power source for charging of the energy storage device 28 can be, for example, a computer, which is connected via the data interface 22 to the remote control 10.

As shown in FIG. 1, there are several operating elements in the form of four buttons 32, 34, 36, and 38 and a “jog-dial” operating element 30. Via these operating elements 30-38, the user can control all suitable functions of the remote control 10. If the remote control 10 is controlled with a computer, for example, in order to exchange data, operation of the remote control 10 can take place in whole or in part via the operating elements of the computer. Furthermore, there is provided an eye 42 with which the remote control 10 can be attached, for example, to a key ring or the like. The dimensions of the remote control 10 are preferably chosen to be small, at least such that the user can easily carry the remote control.

The features of the invention disclosed in the preceding description, the drawing, and in the claims can be used both individually and also in any suitable combination for implementation of the present invention.

1-9. (canceled)

10. A remote control for operation of functions of a motor vehicle, comprising:
a multimedia data memory; and
means for managing said multimedia data memory by a user for performing operation of functions of a motor vehicle.

11. The remote control of claim 10, wherein said functions of said motor vehicle include at least one of heating, ventilation, air conditioning, interlock, antitheft protection, and interrogation of vehicle states and characteristics, including at least one of temperatures and electrical system voltages.

12. The remote control of claim 10, further comprising means for reproduction of multimedia data.

13. The remote control of claim 12, further comprising an interface to which said means for reproduction of said multimedia data is connected.

14. The remote control of claim 10, further comprising means for at least one of compression and decompression of multimedia data.

15. The remote control of claim 10, further comprising an interface via which at least one of configuration data, remote control data, and multimedia data is at least one of sent and received at least one over of a cable, by radio, optically, and by ultrasound.

16. The remote control of claim 10, further comprising a charge controller for charging at least one energy storage device, which supplies the remote control with power.

17. The remote control of claim 10, wherein the multimedia data memory is configured to store at least one of audio data, photo data, and video data.

18. The remote control of claim 10, further comprising at least one operating element, including at least one of buttons and a jog dial.
